(19) United States
(12) Patent Application Publication
(10) Pub. No.: US 2014/0043226 A1
(43) Pub. Date: Feb. 13, 2014

(54) PORTABLE DEVICE AND ASSOCIATED CONTROL METHOD

(71) Applicant: INDUSTRIAL TECHNOLOGY RESEARCH INSTITUTE, Hsinchu (TW)

(72) Inventors: Wei-Yen Lee, Taichung City (TW); Po-Chun Yeh, Tainan City (TW); Heng-Yin Chen, Zhubei City, Hsinchu County (TW)

(21) Appl. No.: 13/937,242

(22) Filed: Jul. 9, 2013

(30) Foreign Application Priority Data
Aug. 8, 2012 (TW) 101128644

(51) Int. Cl. G06F 3/03

(52) U.S. Cl. CPC G06F 3/03
USPC 345/156

(57) ABSTRACT

A portable device and associated control method are provided. The portable device includes a foldable display panel. The control method includes steps of: detecting a folding operation is applied to the display panel; retrieving at least one folding signal; converting a display region of the display panel from an original size to a folded size according to the at least one folding signal; and the display panel displaying an image according to the converted display region. The display panel selects a corresponding folding coordinate system according to the converted display region.

This application claims the benefit of Taiwan application Serial No. 101128644, filed Aug. 8, 2012, the disclosure of which is incorporated by reference herein in its entirety.

### TECHNICAL FIELD

The disclosed embodiments relate in general to a portable device and associated control method, and more particularly to a portable device with a foldable display panel and associated control method.

### BACKGROUND

With the increasing prevalence of portable devices, portability is essential for portable devices such as cell phones and electronic books. Under such considerations, portable devices are often designed to be compact. However, as information and digital contents offered by portable devices get richer, operation handiness of the portable devices may be undesirably affected if an undersized screen is used.

In other words, the design of portable devices faces a dilemma—portable devices need to be light and compact for portability, while a larger display panel is required for displaying the rich contents. As a result, manufacturers of portable devices frequently encounter highly challenging situations to satisfy both of the above conflicting appeals.

Thus, a portable device having a foldable display is developed.

FIG. 1A shows a schematic diagram of a conventional portable device having a foldable display panel, e.g., a transforming tablet device 10 provided by Sony. The transforming tablet device 10 adopts a foldable dual-screen design. Through the top-and-bottom folding storage method, the size of the transforming tablet device 10 is largely reduced.

To present an image with a larger display region, the transforming tablet device 10 displays the image simultaneously by an upper sub-screen 101a and a lower sub-screen 101b. In contrast, only the upper sub-screen 101a is set to display the image when a large display region is not needed.

For example, the user may select a single screen for displaying a window of the music player software when music player software is the only used software. On the other hand, when replying an email, the transforming tablet device 10 may be configured to adopt a full screen, with the upper sub-screen 101a displaying an incoming email and the lower sub-screen 101b displaying a reply being composed by the user.

FIG. 1B shows a schematic diagram of a display mode setting provided by a conventional transforming tablet device. Through a screen compatibility setting page 103, the transforming tablet device allows a user to select a full screen 101 or a single sub-screen for display according to an image size required by a software application.

In other words, the conventional transforming tablet device 10 can only select an appropriate display region by first operating the screen compatibility setting page. In FIG. 1B, a graph pointed by an upper arrow represents that the user selects only the upper sub-screen 101a for display, and a graph pointed by a lower arrow represents that the user selects the full screen 101 for display. A confirm key 105 is pressed after selecting the desired screen size.

The above process of selection and determination for a required screen size needs to be repeatedly performed each time the user switches among different functions.

### SUMMARY

According to one embodiment, a control method applied to a portable device is provided. The portable device comprises a display panel having a foldable function. The control method comprises steps of: detecting a folding operation is applied to the display panel; retrieving at least one folding signal, wherein the at least one folding signal is determined by a position of the folding operation applied on the display panel; converting a display region of the display panel from an original size to a folded size according to the at least one folding signal; and the display panel displaying an image according to the converted display region.

According to another embodiment, a control method applied to a display panel having a foldable function is provided. The control method comprises steps of: retrieving at least one folding signal, wherein the at least one folding signal is determined by a position of a folding operation applied on the display panel; converting a display region of the display panel from an original size to a folded size according to the at least one folding signal; and the display panel selecting a folding coordinate system for touch control according to the converted display region.

According to yet another embodiment, a portable device is provided. The portable device comprises: a display panel, a display panel, having at least one crease position, for displaying an image by a display region; at least one bending sensor, disposed at the at least one crease position, for detecting a folding operation is applied to the at least one crease position, and generate at least one corresponding folding signal; and a control unit, electrically connected to the display panel and the bending sensor, for converting the display region from an original size to a folded size according to the at least one corresponding folding signal.

### BRIEF DESCRIPTION OF THE DRAWINGS

FIG. 1A (prior art) is a schematic diagram of a conventional portable device provided with a foldable display panel;

FIG. 1B (prior art) is a schematic diagram of a display mode setting provided by a conventional transforming tablet device;

FIG. 2A is a schematic diagram of a display panel having a foldable function and being foldable at a crease position along a central axis;

FIG. 2B is a schematic diagram of displaying an image by a full screen according to an embodiment;

FIG. 2C is a schematic diagram of displaying an image in an unadjusted size by a left half screen;

FIG. 2D is a schematic diagram of displaying a reduced image by a left half screen after detecting that a display panel is in a folded state according to an embodiment;

FIG. 2E is a schematic diagram of displaying a reduced image by a right half screen after detecting that a display panel is in a folded state according to an embodiment;

FIG. 3A is a schematic diagram of a bending sensor disposed at a display panel according to an embodiment;

FIG. 3B is a schematic diagram of folding a right half screen to behind a left half screen of a display panel;

FIG. 3C is a schematic diagram of folding a left half screen to behind a right half screen of a display panel;

FIG. 4A is a schematic diagram of a touch operation to be applied to a displayed image;

FIG. 4B is a schematic diagram of a position of a touch point to be selected on a display panel when displaying the image in FIG. 4A using a full screen;

FIG. 4C is a schematic diagram of a position of a touch point to be selected on a display panel when displaying the image in FIG. 4A using a right half screen;

FIG. 4D is a schematic diagram of comparing positioned touch points respectively obtained on the basis of FIGS. 4B and 4C;

FIG. 5A is a block system block diagram of a portable device according to an embodiment;

FIG. 5B is a flowchart of a positioning conversion process for a touch point based on an original coordinate system and a crease position according to an embodiment by taking FIG. 4D as an example;

FIG. 6A is a schematic diagram of rotating a placement of a display panel 90 degrees counterclockwise from a horizontal direction to a vertical direction;

FIGS. 6B and 6C are schematic diagrams of a display panel cooperating with a gyroscope according to an embodiment;

FIG. 6D is a system block diagram of the portable device in FIG. 5A further comprising an acceleration sensor;

FIGS. 7A, 7B and 7C are schematic diagrams of providing a crease position at a central position of a shorter side of a display panel as well as a bending sensor and an acceleration sensor in the display panel according to an embodiment;

FIG. 8 is a flowchart of a control method applied to a portable device comprising a display panel having a foldable function according to a an embodiment;

FIG. 9A is a schematic diagram of two crease positions provided at a display panel;

FIGS. 9B and 9C are schematic diagrams of a display panel folded to a one-third screen for displaying an image according to an embodiment;

FIGS. 10A and 10B are schematic diagrams illustrating a flowchart of a touch point positioning conversion process for the display panel in FIG. 9A;

FIGS. 11A to 11H are schematic diagrams of possible display region combinations generated by the display panel in FIG. 9A;

FIG. 12 is a schematic diagram of a horizontal central line and a vertical central line of a display panel utilized as crease positions as well as bending sensors correspondingly disposed; and

FIG. 13 is a schematic diagram of a system development for a portable device according to an embodiment.

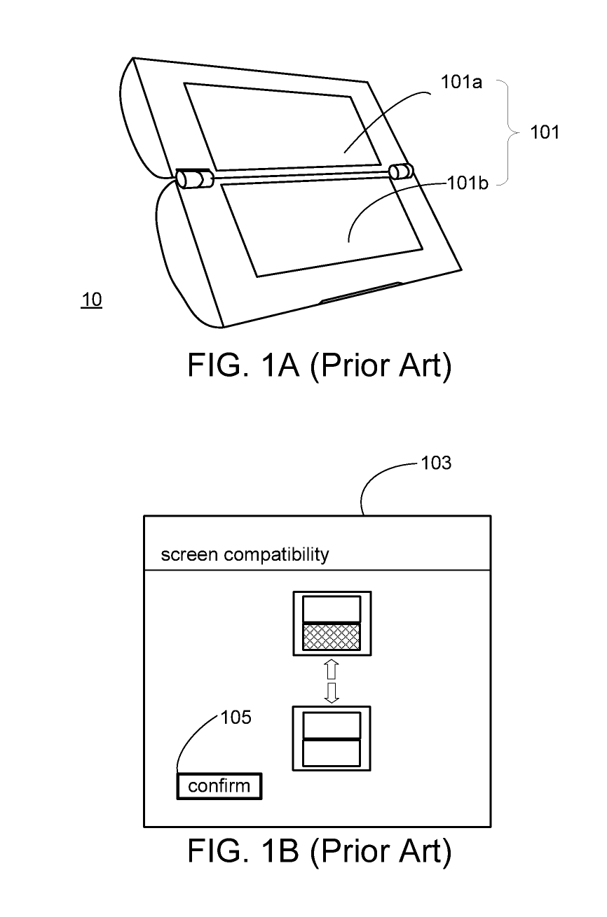

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

As previously described, although foldable display panels are gradually implemented in portable devices, operation of the portable devices is still inconvenient. When a user operates a foldable display panel, a display region is repeatedly required to be set whenever the user changes the application software in use. In the following descriptions, a display region available to the display panel is indicated in regular solid lines, whereas an actual display region for displaying an image on the display panel is indicated in thick solid lines.

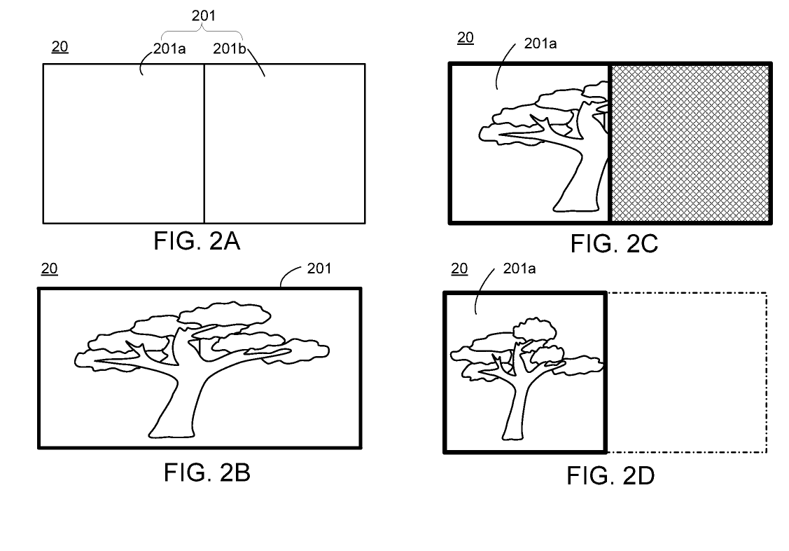

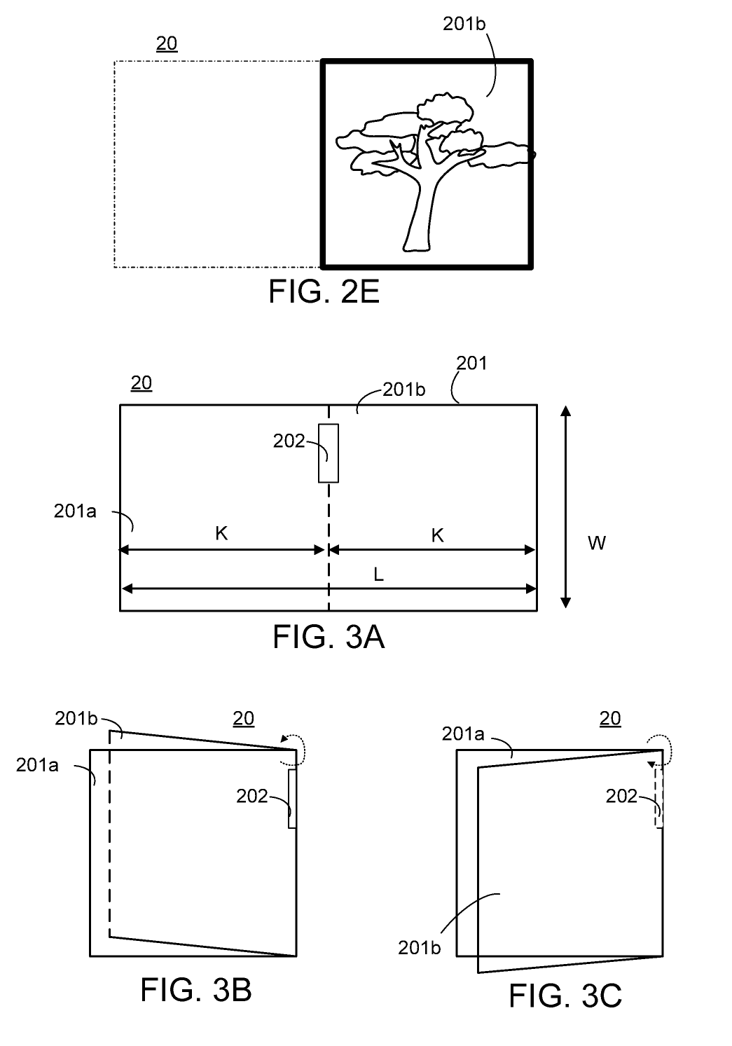

FIG. 2A is a schematic diagram illustrating a foldable display panel, in which a crease is positioned along a central axis. To better explain how a display panel 20 is controlled, it is assumed that an area size of a portable device equals an area size of the display panel according to an embodiment. In practice, the display panel of the portable device may further include a frame. In such situation, the concept of the disclosure may still be applied with slight adjustments.

Referring to FIG. 2A, a full screen of the display panel 20 is divided into a left half region and a right half region. An image may be selectively displayed by a full screen 201, or one of a left half screen 201a and a right half screen 201b.

According to an embodiment, the display panel 20 in FIG. 2A has a crease position disposed at a central line. That is, when operating the display panel 20, a user may fold the right half screen 201b backwards along the crease position, and select to use only the left half screen 201a or only the right half screen 201b for image display.

According to a concept of the disclosure, a screen compatibility setting page is not required for selecting the left half screen 201a or the right half screen 201b for displaying an image. In this embodiment, an appropriate size setting for the display region is automatically provided by the display panel 20 whenever operation environment changes.

For example, when a user operates the portable device at home or in an office, the user may place the portable device on a desk, and the display panel 20 may display an image using a full screen. Alternatively, when the user operates the portable device in a public transportation such as in an airplane or in a subway carriage, the display panel 20 may use only a half screen to display an image since the space is relatively limited.

Assume that an image to be displayed is outlines of a tree. FIGS. 2A to 2E demonstrate a foldable display panel according to an embodiment. The foldable display panel is capable of dynamically selecting a full screen, the left half screen 201a or the right half screen 201b for displaying the image.

FIG. 2B shows a schematic diagram of a display panel displaying an image with a full screen according to an embodiment. When a user is in a spacious environment, the display panel 20 may be completely spread. Under this circumstance, the full screen is automatically selected by the foldable display panel for displaying the image.

FIG. 2C shows a schematic diagram of displaying an image in an unadjusted size by a left half screen.

In FIG. 2C, the left half screen is utilized as a display region, and a right half screen is represented in a shaded area. This diagram indicates that a folding operation is applied to fold the right side of the display panel along a crease position at a central axis towards the back of the display panel. By doing so, the right half screen is placed behind/beneath the left half screen after the folding operation.

As seen from the diagram, the display image should not be displayed by a full screen when the display panel is in a folded state. Otherwise, the user perceives only an incomplete image as shown in FIG. 2C.

Therefore, according to an embodiment, once a folding operation applied to the display panel is detected, the portable device dynamically adjusts the size of the image in response to the folding status of the foldable display panel.

FIG. 2D is a schematic diagram illustrating a left half screen is used for displaying a reduced image when the display panel is folded according to an embodiment. In such case, the left half screen is chosen to be a display region.

In this embodiment, when the right half screen is folded to behind/beneath the left half screen according to a folding operation, the image is automatically reduced to a half of an original size and then displayed.

In FIG. 2D, the horizontal size of the image in FIG. 2B is adjusted, and the image after adjustment is displayed by the left half screen. That is, in FIG. 2D, the image is maintained with a same height as that in FIG. 2B. However, width of the image in FIG. 2D is reduced to one-half of that in FIG. 2B.

In a case that only left half screen is used as shown in FIG. 2D, since the width of the image and the width of the display region provided by the display panel are both adjusted, the image can still be normally displayed.

FIG. 2E shows a schematic diagram of displaying a reduced image by a right half screen after detecting that a display panel is folded according to an embodiment. Details of FIG. 2E are similar to those of FIG. 2D, and shall be omitted herein.

According to illustrations associated with FIGS. 2D and 2E, when the display panel is folded, the display region is either the left half screen 201a or the right half screen 201b.

It is further concluded from FIGS. 2B, 2D and 2E that, given that a crease position is provided at the central line of the display panel, the foldable display panel of the portable device is capable of providing different types of display regions. For instance, one of the full screen in FIG. 2B, the left half screen in FIG. 2D, and the right half screen in FIG. 2E is selected to be the display region.

Further, according to the embodiment, the display regions provided by the display panel are with different sizes. Since the display region is corresponding to the actual display area, the displayed image is also processed by a corresponding size conversion.

FIG. 3A shows a schematic diagram of a bending sensor disposed at a display panel according to an embodiment. In this embodiment, a bending sensor is disposed at a crease position of the display panel. In the event of a folding operation, a bending sensor 202 generates a corresponding folding signal. Further, the folding signal generated by the bending sensor 202 serves as a basis for determining whether a folding operation is applied to the display panel. In addition, the folding signal also represents the position and direction of the folding operation.

In FIG. 3A, a display region initially provided by the foldable display panel is depicted in a rectangle of L*W. The foldable display panel is with the crease position located at a central position L/2(K=L/2). Once the display panel is folded, the folding status of the display panel corresponds either of two candidate display configurations. One candidate display configuration is provided by the left half screen and the other is provided by the right half screen. In FIG. 3A, the display region corresponding to the left half screen is equal to a left rectangle in a size K*W, and the display region corresponding to the right half screen is equal to a right rectangle in a size K*L.

As previously stated, the display panel of the portable device may be folded into a smaller size to adapt to a user ambient environment. However, although the display panel is folded along the same crease position, an actual display region may be different if folding direction changes.

FIG. 3B shows a schematic diagram of folding a right half screen to behind a left half screen of a display panel. FIG. 3B represents a backward folding operation applied to the right half screen of the display panel in FIG. 3A. Through the folding signal generated by the bending sensor 202, the folding direction and folding approach of the display panel can be determined.

FIG. 3C shows a schematic diagram of folding a left half screen to behind a right half screen of a display panel. When the display panel supports dual-side display, a user may selectively fold the display panel towards the front of towards the back as desired. FIG. 3C depicts a forward folding operation applied to the right half screen of the display panel in FIG. 3A. Through the folding signal generated by the bending sensor 202, the folding direction and folding approach of the display panel can be determined.

It is concluded from illustrations associated with FIGS. 3A, 3B and 3C that, by disposing a bending sensor at a crease position of a foldable display panel, whether the display panel is folded, an actual folding direction, a folding approach, and size of a display region after the folding operation can be obtained according to contents of a folding signal.

Touch control is often utilized as an operation interface in portable devices. According to an embodiment, assuming that a touch control display panel is foldable, an approach for positioning a touch point may also be dynamically adjusted according to a folding status of the display panel.

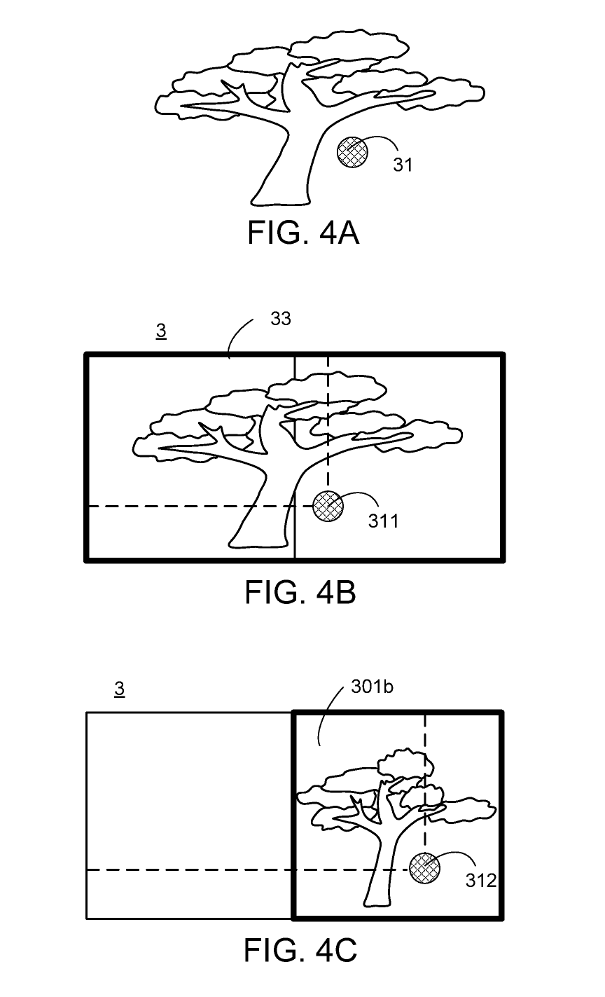

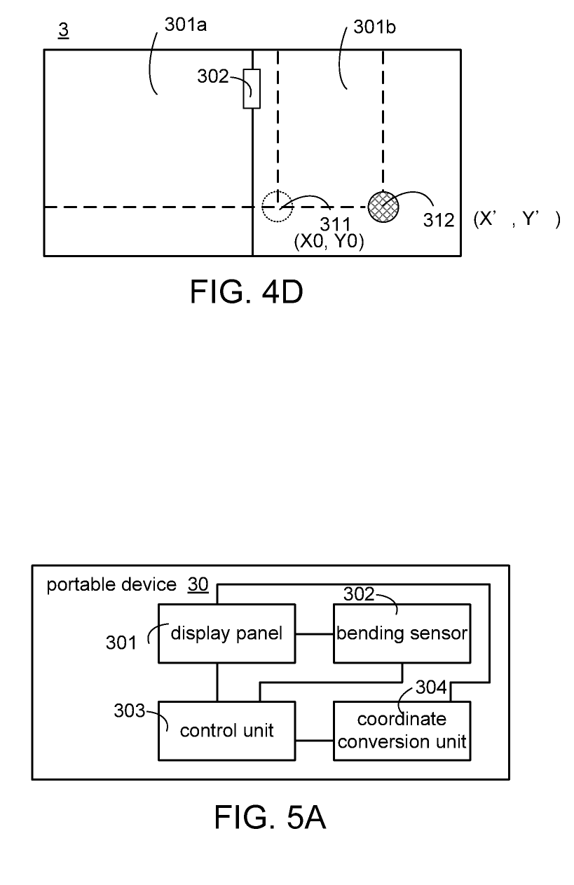

FIG. 4A shows a schematic diagram of a touch operation to be applied to a displayed image. Assume that a touch point 31 selected by a user is below a right branch of a tree trunk. In the description below, details of adjusting a positioning method for a touch point in response to a change of a display region are explained.

FIG. 4B shows a schematic diagram of a position of a touch point to be selected on a display panel when displaying the image in FIG. 4A using a full screen. When displaying the image in FIG. 4A by a full screen 33, a horizontal position of a touch point position 311 is relatively close to a central line of the display panel if a touch operation is executed below the right branch branched from the tree trunk.

FIG. 4C shows a schematic diagram of a position of a touch point to be selected on a display panel when displaying the image in FIG. 4A using a right half screen. In other words, FIG. 4C is further providing a touch control function to the display panel in FIG. 2E. Although the position of the touch point has a same height on the display panels in FIGS. 4B and 4C, a touch point position 312 is located at approximately a center of the right half screen when displaying the image by the right half screen shown in FIG. 4C.

On the bases of the touch control situations in FIGS. 4B and 4C, details for positioning a touch point on a display panel are discussed with reference to FIG. 4D below.

FIG. 4D shows a schematic diagram of comparing positioned touch points respectively obtained on the basis of FIGS. 4B and 4C. It is also assumed that the bending sensor 302 is disposed at a central line of the display panel 3. When a user performs a touch operation on the full screen in FIG. 4B, a touch point position 311 selected by the touch operation in FIG. 4A is (X0, Y0).

However, when a user performs a touch operation on a left half screen 301a or a right half screen 301b, the touch point coordinates are no longer (X0, Y0). For example, in FIG. 4D, a touch point position 312 at the right half screen 301b should be represented as (X′, Y′).

In other words, when a same touch operation is performed on a same image, the approach for positioning a touch point may be different if an actual display region provided by the foldable display panel is changed.

In conclusion from the foregoing description, given that a bending sensor is disposed at a crease position of the display panel, a folding status of a display panel can be detected. Hence, an image in a corresponding size can then be provided with respect to the folding status of the display panel. In addition to the size conversion of an image, a method for converting coordinates of a touch point for adapting a change in the positioning for a touch point is further provided by an embodiment.

That is to say, according to an embodiment, apart from providing an image according to a folding status change of a display panel, a portable device is also capable of automatically adjusting and compensating a coordinate position of the touch point.

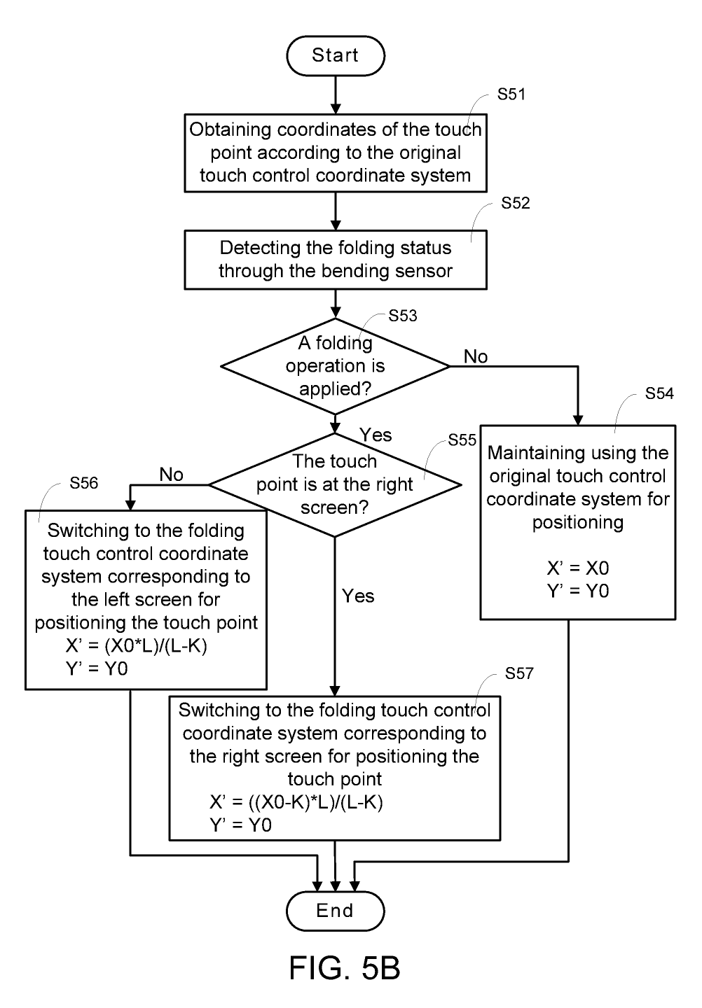

FIG. 5A shows a system block diagram of a portable device according to an embodiment. In this embodiment, a portable device 30 includes a display panel 301, a bending sensor 302 and a control unit 303.

For a display panel supporting touch control, the portable device 30 further includes a coordinate conversion unit 304.

A display panel has an original size before being folded. The display panel 301 has at least one crease position and a foldable function. A folding operation can be applied to the display panel only along a crease position. Once a folding operation is applied to the crease position, a bending sensor disposed at the crease position generates a corresponding folding signal.

With the known crease position corresponding to the disposed bending sensor, it can then be determined whether a folding operation is applied to the crease position according to the folding signal generated by the bending sensor. For example, in FIG. 3A, the bending sensor generates a corresponding folding signal when the display panel is folded along the central line.

It should be noted that a display panel may have a plurality of crease positions and a plurality of bending sensors. When a portable device includes a plurality of bending sensors, actual candidate display configurations of the display panel can be determined according to the corresponding folding signals generated by the bending sensors.

A candidate display configuration refers to a type of a display region provided by a display panel according to a crease position of the display panel. In the foregoing example, the display panel has one crease position, and so three candidate display configurations are provided by the display panel in FIG. 3A. The three candidate display configurations are a full screen, a left half screen and a right half screen.

The control unit 303, electrically connected to the display panel 301 and the bending sensor 302, selects a corresponding candidate display configuration according to the folding signal generated by the bending sensor 302. For example, an original size (e.g., a full screen) of the display region of the display panel is converted to a folded size (e.g., a half screen). Further, the control unit 303 also controls the display panel 301 to display the image in response to the adjusted size when the size of the display region is adjusted.

When the display panel 301 supports touch control function, the portable device further includes a coordinate conversion unit 304 electrically connected to the display panel 301. In response to display regions in an original size and a folded sized, the coordinate conversion unit 304 respectively provides an original coordinate system and a folding coordinate system for positioning the touch point.

With reference to illustrations associated with FIG. 4D, when the display region is in the original size, the coordinate conversion unit 304 positions the touch point through the original coordinate system as (X0, Y0). When the display region is in the folded size, the coordinate conversion unit 304 positions the touch point through the folding coordinate system as (X′, Y′). According to an embodiment, the coordinate conversion unit 304 may be implemented by an independent hardware circuit, integrated in a timing controller of the display panel, or implemented by a software program for performing the coordinate conversion process etc.

Under certain circumstances, an original size provided by a display panel is a full-screen size, and the display panel provides a touch control function with respect to the full screen. That is to say, the original size and the approach for positioning a touch point using an original coordinate system are known. Therefore, when the display panel is folded to a smaller folded size, the position of the touch point to be presented by a folding coordinate system can be inferred according to the known original touch control system and the crease position actually being folded.

Taking FIG. 4D for example, FIG. 5B shows a flowchart of a positioning conversion process for a touch point based on an original coordinate system and a crease position according to an embodiment.

In step S51, coordinates of the touch point are obtained according to the original coordinate system. In step S52, the folding status of the display panel is detected through the bending sensor. In Step S53, it is detected whether a folding operation is applied.

According to a determination result of whether the folding operation is applied to the display panel 301, it is selected whether the original coordinate system is maintained for positioning the touch point in step S54, or whether to switch to a positioning method for the touch point corresponding to the folding status.

When the display panel 301 is not folded, the control unit 303 keeps using the original coordinate system for positioning, and the horizontal coordinate position and the vertical coordinate position need not be changed at this point, i.e., X′=X0 and Y′=Y0.

When the determination result in step S53 indicates that the display panel is in a folded state, a display configuration is determined from a plurality of candidate display configurations. The touch point is hence positioned by an appropriate folding coordinate system.

In step S55, when it is detected that the display panel 301 is folded, the position of the touch point is further determined.

When a detection result in step S55 is negative, it means that the position of the touch point is at the left half screen, and the position method for the touch point is switched to the folding coordinate system corresponding to the left half screen in step S56. Taking the display panel in FIG. 3A for example, the coordinates of the touch point are converted from (X0, Y0) of the original coordinate system to (X′, Y′)=((X0*L)/(L−K), Y0) of the folding coordinate system.

When the detection result in step S55 is affirmative, it means that the position of the touch point is at the right half screen, and the positioning method for the touch point is switched to the folding coordinate system corresponding to the right half screen in step S57. Taking the display panel in FIG. 3A for example, the coordinates of the touch point are converted from (X0, Y0) of the original coordinate system to (X′, Y′)=((X0*K)*L/(L−K), Y0) of the folding coordinate system.

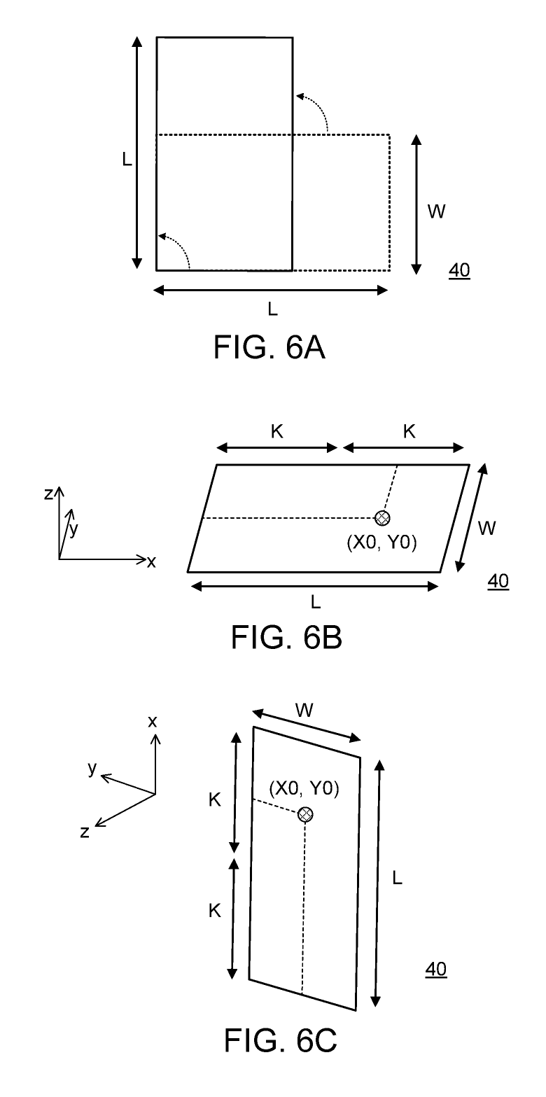

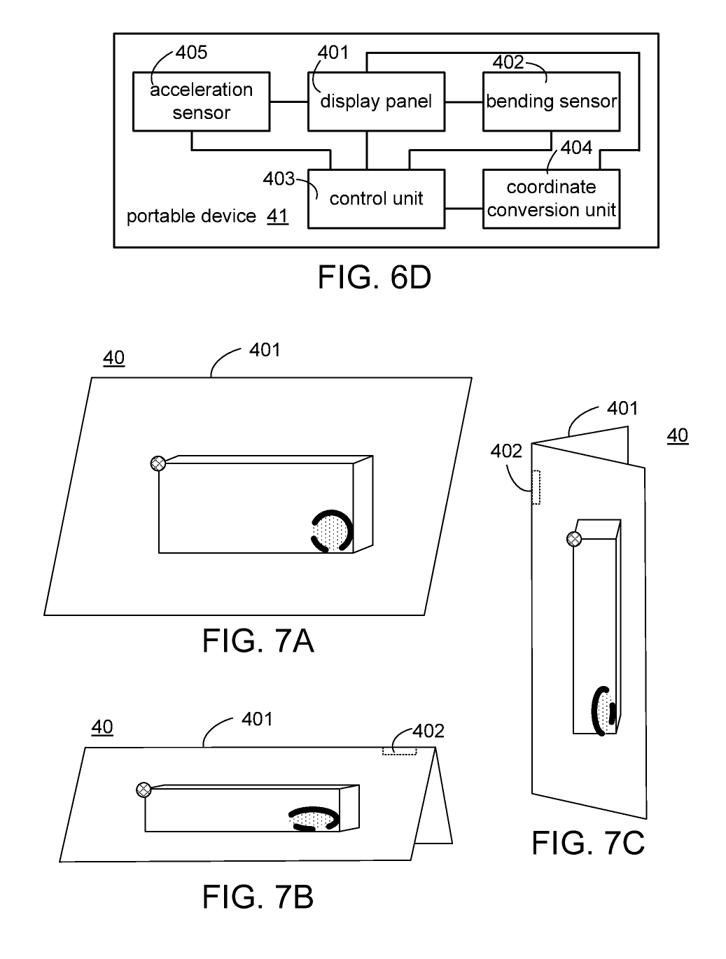

FIG. 6A is a schematic diagram illustrating placement of a display panel is rotated counterclockwise by 90 degrees, from a horizontal direction to a vertical direction. A display panel 40, in an original placement of having a longer side parallel to the horizontal direction and a shorter side parallel to the vertical direction, is rotated by a rotation angle (e.g., 90 degrees). After being rotated, the display panel 40 is in a placement of having the longer side parallel to the vertical direction and the shorter side parallel to the horizontal direction.

According to an embodiment, a portable device may further include an acceleration sensor (e.g., a gyroscope) for fulfilling application requirements of rotations. A gyroscope is a device for sensing and maintaining direction. Thus, when a display panel is rotated, the gyroscope may correspondingly sense the direction and the rotation angle of the rotation operation.

FIGS. 6B and 6C are schematic diagrams of a display panel coordinating with a gyroscope according to an embodiment.

When the display panel is changed from the placement in FIG. 6B to the placement in FIG. 6C, the gyroscope senses that the display panel is rotated. Thus, through a rotation signal generated by the gyroscope, the control unit correspondingly rotates an image before transmitting the image to the display panel. Since the displayed image is automatically rotated in advance, a user will not see an obliquely displayed image. Further, the control unit also transmits details of the rotation of the display panel to the coordinate conversion unit. Therefore, the coordinate conversion unit may further utilize these rotation details before positioning the touch point.

FIG. 6D shows a system block diagram of a portable device 41 in FIG. 5A further including an acceleration sensor. Functions of a display panel 401, a bending sensor 402, a coordinate conversion unit 404 and a control unit 403 are similar to those associated with FIG. 5A, and shall be omitted herein.

The acceleration sensor 405 is electrically connected to the display panel 401 and the control unit 403. The acceleration sensor 405 senses a rotation operation applied to the display panel 401 and generates a rotation signal, so as to allow the control unit 403 to convert configuration of the display region from a pre-rotation width-height setting to a post-rotation width-height setting according to the rotation signal.

With the above embodiments, a display and touch control compensation method is provided to a foldable display panel of a portable device in response to a folding operation. Regardless of which candidate display configuration is adopted, a corresponding coordinate system can be provided by a control unit according to a size conversion of the image. In addition, the coordinate conversion unit provides a suitable converted coordinate system according to the adopted candidate display configuration.

FIGS. 7A, 7B and 7C show schematic diagrams of providing a crease position at a central position of a shorter side of a display panel as well as a bending sensor and an acceleration sensor in the display panel according to an embodiment.

In FIG. 7A, a rectangular parallelepiped image is displayed by a full screen. It is further assumed that a position selected by a touch point is at an upper left corner of a front side of the rectangular parallelepiped. To better identify relative position changes when displaying the rectangular parallelepiped, a shaded circular identification pattern is provided at a diagonal position to the touch point at the front side of the rectangular parallelepiped is depicted.

FIG. 7B shows a situation of using a half screen as a display region after applying a folding operation at a crease position of a display panel. Compared to FIG. 7A, a width of the display region in FIG. 7B is reduced to a half of an original width although a length of the display region is maintained the same. Therefore, although a length of the rectangular parallelepiped is unchanged, a height of the rectangular parallelepiped is reduced to a half of an original height.

Similarly, as the width of the display region is reduced, the original circular identification pattern may appear longer as an ellipsoidal since the appearance of the display region is changed.

FIG. 7C shows the display panel in FIG. 7B rotated by 90 degrees. As a direction and a rotation angle of the rotation operation can be correspondingly sensed by a gyroscope, the gyroscope transmits a rotation signal when sensing that the display panel is rotated. Thus, when a control unit controls the display panel to output the image or converts the coordinate system, the rotation signal can also be considered to provide a corresponding operation.

Thus, when the display panel is further rotated to a placement with the long axis parallel to the vertical direction, the identification pattern that is originally located close to the shorter side of the bending sensor becomes being located close to an end of the other side. In other words, when the acceleration sensor is not provided, the identification pattern should be located at the upper right of the image instead of at the lower right shown in FIG. 7C.

According to an embodiment, the display panel is capable of adjusting a presentation method of the displayed image by use of the gyroscope that senses the rotation of the display panel.

When the display image is rotated from as shown in FIG. 7B to as shown in FIG. 7C, the sides along the horizontal direction and the vertical direction are changed. Therefore, the longer side originally parallel to the horizontal direction becomes parallel to the vertical direction. And, the shorter side originally parallel to the vertical direction becomes parallel to the horizontal direction.

After the display panel in FIG. 7B is rotated 90 degrees counterclockwise, the horizontal direction in the displayed image becomes being displayed by the shorter side, such that the contents along the horizontal direction are displayed in a smaller scale. Similarly, after the display panel in FIG. 7B is rotated 90 degrees counterclockwise, the vertical direction in the displayed image becomes being displayed by the longer side, such that the contents along the vertical direction are displayed in a larger scale.

Comparing FIGS. 7B and 7C, despite that the display contents are the same rectangular parallelepiped, the horizontal longer side of the former is reduced to the shorter side of the latter, and the vertical shorter side of the former is stretched to the longer side of the latter.

Further, the touch point and the identification pattern remains at a relative position when being displayed in response to the rotated display panel. From FIG. 7C, it is observed that the touch point remains at the upper left of the display image and the identification pattern remains at the lower right of the display image after the display panel is rotated.

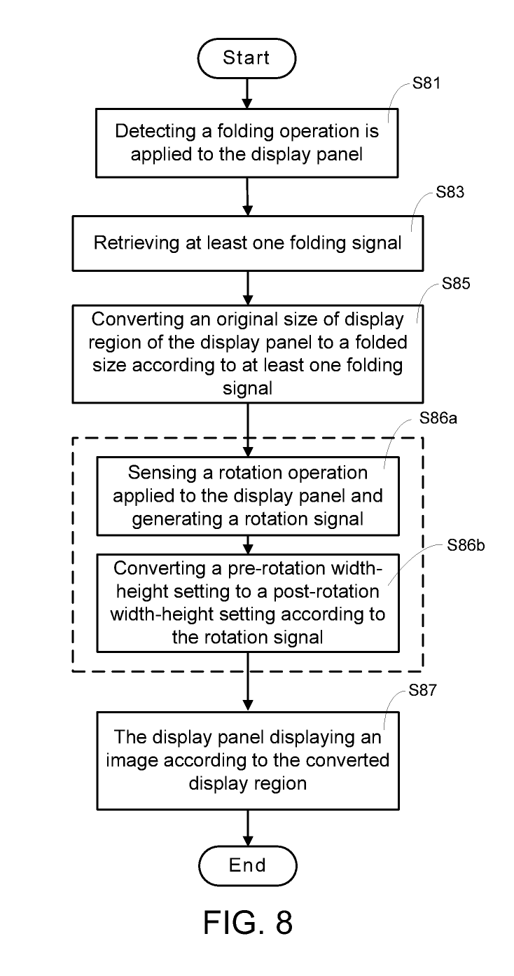

FIG. 8 shows a flowchart of a control method applied to a portable device comprising a display panel having a foldable function according to an embodiment.

In step S81, it is detected that a folding operation is applied to the display panel. In step S83, determined by a position of the folding operation applied on the display panel, at least one folding signal is retrieved consequently.

In step S85, according to the at least one folding signal, an original size of a display region of the display panel is converted to a folded size. In step S87, the display panel displays an image according to the converted display region. As mentioned before, the converted display region in step S87 is with the folded size.

Step S85 of converting the original size of the display panel to the folded size according to contents of the folding signal may further include the following steps.

A folding status of the display panel is determined according to the at least one folding signal. For example, a folding direction is determined when only one crease position is present on the display panel. When a plurality of crease positions are present on the display panel, at which of the crease positions the folding operation is applied are determined, so as the folding directions corresponding to these crease positions. Different folding statuses respectively correspond to a plurality of candidate display configurations, and each of the candidate display configurations corresponds to a display size.

Once the folding status of the display panel is determined, one of the candidate display configurations corresponding to the folding status is selected, and the folded size is set as the corresponding display size. The size of the display region is then changed and/or converted from the original size to the folded size.

When the display panel supports touch control function, a touch point positioning method needs to be further determined in response to different folding statuses of the display panel in addition to the foregoing process. Therefore, when the display region is with an original size, the display panel senses the position of the touch point according to an original coordinate system for touch control. When the display region is with a folded size, the display panel senses the position of the touch point according to a folding coordinate system for touch control.

When the portable device includes the acceleration sensor as shown in the block diagram in FIG. 6D, the process further includes the following steps between step S85 and step S87.

In step S86a, a rotation operation applied to the display panel is sensed and a rotation signal is generated. In step S86b, according to the rotation signal, the configuration of the display region is converted from a pre-rotation width-height setting to a post-rotation width-height setting.

According to different system requirements and considerations of the portable device, the number of crease positions provided by the display panel may also be different. When the display panel provides a plurality of crease positions, different bending sensors are disposed at different crease positions.

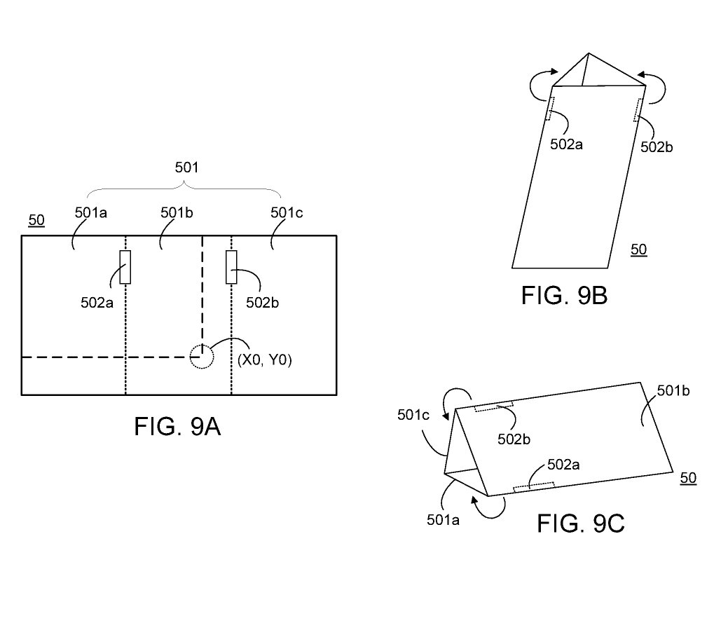

FIG. 9A shows a schematic diagram of two crease positions provided at the display panel. In FIG. 9A, assume that a display panel 50 has two crease positions at a horizontal longer side. One of the crease positions is located at one-third of the display panel 50 from the left, and the other is located at one-third of the display panel 50 from the right. Bending sensors 502a and 502b are respectively disposed at the two crease positions.

Thus, in addition to providing a full screen 501 as a candidate display configuration, the display panel 50 in FIG. 9A may select a combination of a left one-third screen 501a, a middle one-third screen 501b and a right one-third screen 501c as a display region.

FIGS. 9B and 9C show schematic diagrams of a display panel folded to a one-third screen for displaying an image according to an embodiment. In FIG. 9B, a longer side of the display panel is divided into three equal parts, which are then folded along the vertical direction. In FIG. 9C, the display panel in FIG. 9B is further rotated by 90 degrees.

Apart from the folding method shown in FIGS. 9B and 9C, the display panel in FIG. 9A may also be folded by other folding methods, and may also display an image by a display region of two-third of the screen. Such modifications are applications variations that can be implemented by a person having ordinary skill in the art.

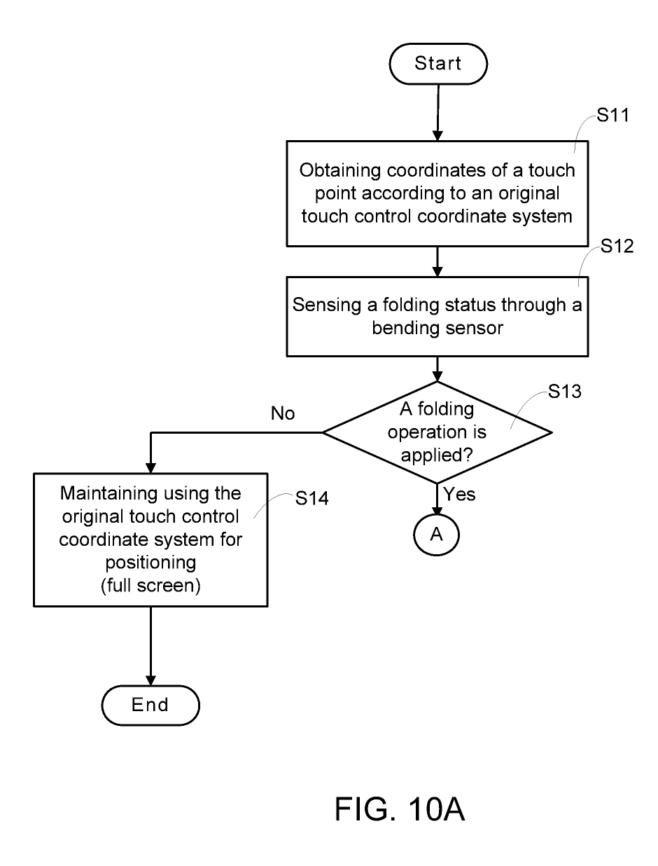

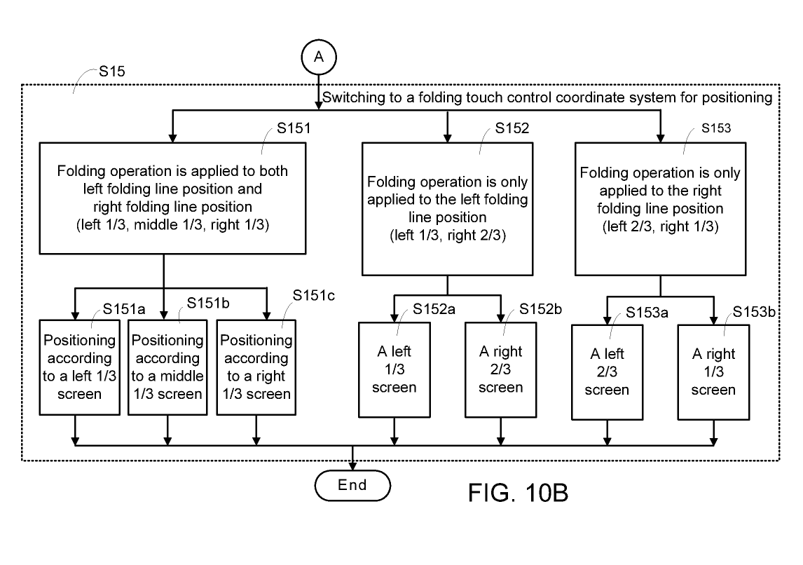

FIGS. 10A and 10B are schematic diagrams illustrating a flowchart of a touch point positioning conversion process for the display panel in FIG. 9A.

In step S11, coordinates of a touch point are obtained according to an original coordinate system. In step S12, by detecting whether a folding operation is applied to a crease position through a bending sensor, a folding status of the display panel is accordingly determined.

According to a detection result of whether a folding operation is applied to the display panel in step S13, it is selected whether to maintain using the original coordinate system for positioning the touch point in step S14, or whether to switch to a positing method corresponding to the folding status for positioning the touch point in step S15. That is, when the display panel is not folded, the control unit keeps using the original coordinate system for positioning the touch point.

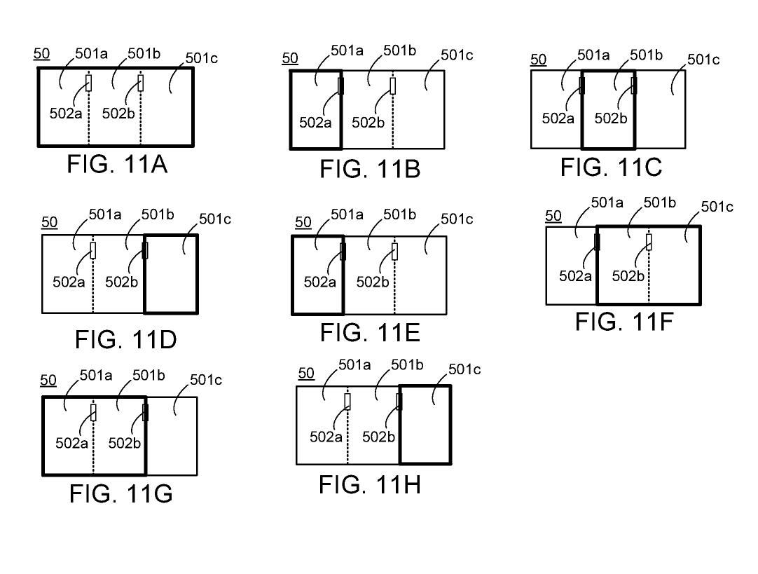

In step S15, different folding coordinate systems are provided according to different folding statuses and possible candidate display configurations. Details of step S15 are described below with reference to FIGS. 11A to 11H.

FIGS. 11A to 11H show schematic diagrams of possible display region combinations generated by the display panel in FIG. 9A. In the diagrams, an actual display region is indicated in thick solid lines. The display region combinations provided by the display panel in FIG. 9A are categorized into four types.

The first type is the situation in step S14 in FIG. 10A, i.e., a full screen type shown in FIG. 11A. At this point, neither of the bending sensors senses a folding operation. Thus, the first type provides only one candidate display configuration.

The second type is the situation in step S151 in FIG. 10B. Step S151 is further divided into three situations including step 5151a corresponding to FIG. 11B, step 5151b corresponding to FIG. 11C and step S151c corresponding to FIG. 11D.

In the second type, both of the bending sensors sense a folding operation applied to the crease positions. At this point, the display panel provides three candidate display configurations. That is, a left one-third screen (step S151a, FIG. 11B), a middle one-third screen (step S151b, FIG. 11C), and a right one-third screen (step S151c, FIG. 11D) are provided.

The third type is the situation in step S152 in FIG. 10B. Step S152 may be further divided into step S152a corresponding to FIG. 11E, and step S152b corresponding to FIG. 11F.

In the third type, a folding operation is applied to only the left crease position. At this point, only the left bending sensor generates a corresponding folding signal, and the display panel provides two candidate display configurations. That is, a left one-third screen (step S152a, FIG. 11E), and a middle/right two-thirds screen (step S152b, FIG. 11F) are provided.

The fourth type is the situation in step S153 in FIG. 10B. Step S153 may be further divided into step S153a corresponding to FIG. 11G, and step S153b corresponding to FIG. 11H.

In the fourth type, a folding operation is applied to only the right crease position. At this point, only the right bending sensor generates a corresponding folding signal, and the display panel provides two candidate display configurations. That is, a middle/left two-thirds screen (step S153a, FIG. 11G) and a right one-third screen (step S153b, FIG. 11H) are provided.

It is seen from illustrations above, for different numbers of the crease positions and different actual positions of the folding operations, the number of candidate display configurations provided by the display panel also differs. Thus, when selecting a display region, the display region currently utilized by the display panel is first determined according to the folding signals generated by the bending sensors before appropriate image and touch control operation can be provided.

In the foregoing embodiments, the crease positions located parallel to the shorter side of the display panel are taken as an example. In the description below, an example of crease positions perpendicular to each other is given.

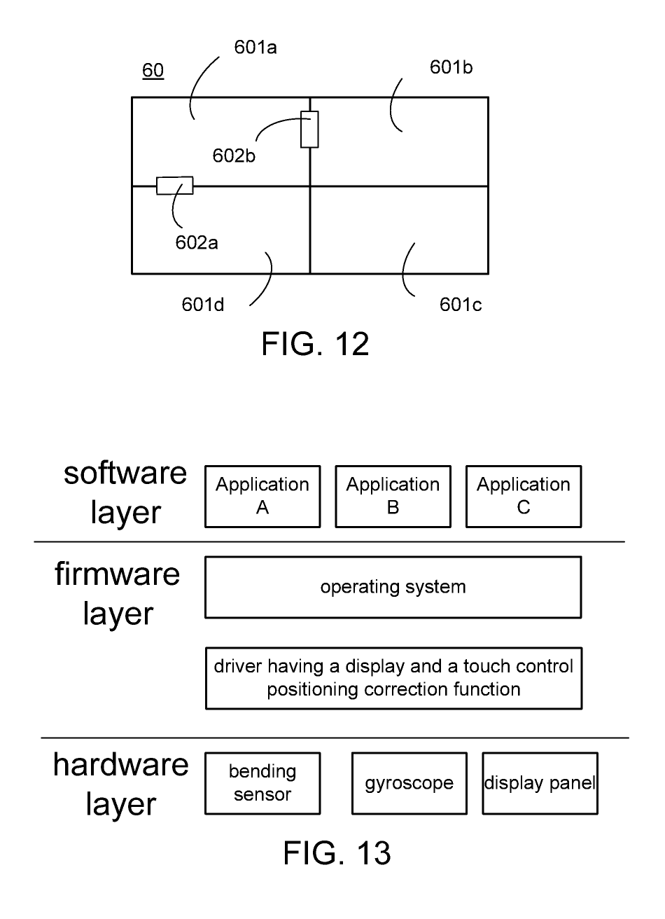

FIG. 12 shows a schematic diagram of a horizontal central line and a vertical central line of a display panel utilized as crease positions, and bending sensors correspondingly disposed.

A bending sensor 602a is disposed at the horizontal crease position, and a bending sensor 602b is disposed at the vertical crease position. The bending sensor 602a may sense an up-down folding operation, and the bending sensor 602b may sense a left-right folding operation of the display panel 60. In the event that folding signals are consequently retrieved by both the bending sensors 602a and 602b, it means that the display panel 60 is folded to one-fourth of an original size.

Except the situation of a full screen, possible candidate display configurations provided by the display panel may change due to different crease positions of actual folding operations.

For example, when a folding operation is applied to only the vertical crease position, possible candidate display configurations provided by the display panel may be the left half screen and the right half screen.

When a folding operation is applied to only the horizontal crease position, possible candidate display configurations provided by the display panel may be the upper half screen and the lower half screen.

When a folding operation is applied to the crease positions in both directions, the display panel 60 may provide an upper-left quarter screen 601a, an upper-right quarter screen 601b, a lower-left quarter screen 601d and a lower-right quarter screen 601c as candidate display as candidate display configurations.

Several situations below are concluded from the descriptions of the above embodiments. An original size of a display region also appears as a rectangle since a common display panel is rectangular. Assume that the sides of the rectangle are in a first direction and a second direction, with the first direction being horizontal and the second being vertical. A first display side of the display region is parallel to the first direction, and a second display side of the display region is parallel to the second direction. Further, a crease position may be parallel to the first direction or the second direction.

When the crease position is parallel to the first direction, it is in equivalence applying the folding operation to the second display side of the display region. Thus, after the folding operation, the length of the second display side is reduced. In contrast, when the crease position is parallel to the second direction, it is in equivalence applying the folding operation to the first display side of the display region. Thus, after the folding operation, the length of the first display side is reduced.

Therefore, it is known from the foregoing descriptions that, regardless of whether a folding operation and/or a rotation operation is applied, the described embodiments are capable of flexibly selecting a most appropriate approach for displaying an image and providing a touch point positioning conversion in response to an operation status of the display panel.

FIG. 13 shows a schematic diagram of a system development for a portable device according to an embodiment.

According to one embodiment, a hardware layer of the portable device includes a bending sensor, a gyroscope, and a foldable display panel. The foldable display panel having a touch control method in response to a change in a display region.

According to the bending sensor and the gyroscope, the touch control method of the display panel in principle performs a coordinate conversion when a touch operation is generated. That is, if a folding operation is performed at the crease position corresponding to position of the bending sensor, a folding signal will be generated by the bending sensor. It should be noted that contents of the folding signals will vary if the crease position of the folding operation changes. The contents of the folding signals are used for determining a size conversion of the display region. The display panel hence changes the display region from an original size to a folded size, and selects a corresponding folding coordinate system in response to the size conversion of the display region.

The hardware devices may be operable through corresponding drivers, e.g., obtaining the folding signal sensed by the bending sensor, obtaining a rotation signal generated by the gyroscope and controlling the display panel to adjust the size of the display region. One or more drivers may be implemented for providing functions such as display region conversion, and touch control positioning correction. Further, an operating system may also be selectively adopted with the above.

Whether an operating system is adopted, upper-layer applications (e.g. application A, B, C etc.) may directly control the converted image and touch point positioning. That is, without considering how a user folding operation is applied to the display panel, upper-layer applications may directly employ calling functions provided by a driver layer. Thus, the upper-layer applications at the software layer can be flexibly exercised to significantly enhance system performance during development of the portable device.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A control method, applied to a portable device, the portable device comprising a display panel having a foldable function, the control method comprising steps of:
detecting a folding operation is applied to the display panel;
retrieving at least one folding signal, wherein the at least one folding signal is determined by a position of the folding operation applied on the display panel;
converting a display region of the display panel from an original size to a folded size according to the at least one folding signal; and
the display panel displaying an image according to a converted display region.

2. The control method according to claim 1, wherein the display panel comprises at least one crease position, and the folding operation is applied to the at least one crease position.

3. The control method according to claim 2, wherein the portable device further comprises at least one bending sensor, and the at least one bending sensor is disposed at the at least one crease position.

4. The control method according to claim 3, wherein the bending sensor correspondingly generates the at least one folding signal when the folding operation is applied to the crease position where the bending sensor is disposed.

5. The control method according to claim 2, wherein the step of converting the display region of the display panel from the original size to the folded size according to the at least one folding signal comprises steps of:
determining a folding status of the display panel according to the at least one folding signal, wherein the folding status corresponds to a plurality of candidate display configurations, and each of the plurality of candidate display configurations corresponds to a display size;
selecting one from the plurality of candidate display configurations, and setting the folded size as the display size corresponding to the selected candidate display configuration; and
changing the display region from the original size to the folded size.

6. The control method according to claim 2, wherein a first display side of the display panel is parallel to a first direction, and a second display side of the display region is parallel to a second direction, wherein the first and the second directions are perpendicular, and the at least one crease position is parallel to either the first direction or the second direction.

7. The control method according to claim 6, wherein a length of the second display side is reduced in response to the folding operation when the at least one crease position is parallel to the first direction;
and the length of the first display side is reduced in response to the folding operation when the at least one crease position is parallel to the second direction.

8. The control method according to claim 1, wherein the display panel having at least one crease position and a touch control function for sensing a position of a touch point, the control method further comprising steps of:
the display panel sensing the position of the touch point with an original coordinate system for touch control when the display region is with the original size; and
the display panel sensing the position of the touch point with a folding coordinate system for touch control when the display region is with the folded size,
wherein the folding coordinate system is obtained according to the original coordinate system and the at least one crease position.

9. The control method according to claim 1, further comprising steps of:
sensing a rotation operation applied to the display panel and correspondingly generating a rotation signal; and
converting configuration of the display region from a pre-rotation width-height setting to a post-rotation width-height setting according to the rotation signal.

10. The control method according to claim 9, wherein a first display side of the display region is parallel to a horizontal direction, and a second display side of the display region is parallel to a vertical direction when the configuration of the display region is the pre-rotation width-height setting; and
the first display side is parallel to the vertical direction, and the second display side is parallel to the horizontal direction when the configuration of the display region is the post-rotation width-height setting.

11. A control method, applied to a display panel having a foldable function, comprising steps of:
retrieving at least one folding signal, wherein the at least one folding signal is determined by a position of a folding operation applied on the display panel;
converting a display region of the display panel from an original size to a folded size according to the at least one folding signal; and
selecting a folding coordinate system for touch control on the display panel according to the converted display region.

12. A portable device, comprising:
a display panel, having at least one crease position, for displaying an image on a display region;
at least one bending sensor, disposed at the at least one crease position, for detecting a folding operation is applied to the at least one crease position, and generate at least one corresponding folding signal; and
a control unit, electrically connected to the display panel and the bending sensor, for converting the display region from an original size to a folded size according to the at least one corresponding folding signal.

13. The portable device according to claim 12, wherein the at least one bending sensor generates the at least one corresponding folding signal according to the crease position and a folding direction of the folding operation after selecting one of a plurality of candidate display configurations provided by the display panel, wherein the display panel is with the original size before being folded, and the selected candidate display configuration is with the folded size after the display panel is folded.

14. The portable device according to claim 12, wherein a first display side is parallel to a first direction and a second display side is parallel to a second direction, wherein the first and the second directions are perpendicular, and the at least one crease position is parallel to either the first direction or the second direction.

15. The portable device according to claim 14, wherein a length of the second display side is reduced in response to the folding operation when the at least one crease position is parallel to the first direction;
and the length of the first display side is reduced in response to the folding operation when the at least one crease position is parallel to the second direction.

16. The portable device according to claim 12, the display panel having a touch control function for sensing a touch point, the portable device further comprising:
a coordinate conversion unit, electrically connected to the display panel, for providing an original coordinate system when the display region is the original size, and a folding coordinate system when the display region is the folded size,
wherein the folding coordinate system is obtained according to the original coordinate system and the at least one crease position.

17. The portable device according to claim 16, wherein the coordinate conversion unit is implemented by an independent hardware circuit, integrated in a timing controller, or implemented by a software program.

18. The portable device according to claim 12, further comprising:
an acceleration sensor, electrically connected to the display panel and the control unit, for sensing a rotation operation applied to the display panel, and generating a rotation signal, wherein the control unit converts the configuration of the display region from a pre-rotation width-height setting to a post-rotation width-height setting according to the rotation signal.

19. The portable device according to claim 18, wherein
a first display side of the display region is parallel to a horizontal direction, and a second display side of the display region is parallel to a vertical direction when the configuration of the display region is the pre-rotation width-height setting; and
the first display side is parallel to the vertical direction, and the second display side is parallel to the horizontal direction when the configuration of the display region is the post-rotation width-height setting.

20. The portable device according to claim 18, wherein the acceleration sensor is a gyroscope.
